(19) United States
(12) Patent Application Publication
(10) Pub. No.: US 2004/0081816 A1
(43) Pub. Date: Apr. 29, 2004

(54) Small cross-section composites of longitudinally oriented fibers and a thermoplastic resin as concrete reinforcement

(76) Inventors: Aleksander J. Pyzik, Midland, MI (US); Christopher Michael Edwards, Midland, MI (US); David Vanderpool, Wellesley Hills, MA (US)

Correspondence Address: THE DOW CHEMICAL COMPANY, INTELLECTUAL PROPERTY SECTION, P. O. BOX 1967, MIDLAND, MI, 48641-1967, US

(21) Appl. No.: 10/283,001

(22) Filed: Oct. 29, 2002

(51) Int. Cl. B32B 27/04

(52) U.S. Cl. 428/297.4

(57) ABSTRACT

Small cross-section fiber-reinforced composites are used as reinforcements for concrete. The composites, which are preferably longitudinally oriented continuous fibers embedded in a thermoplastic matrix, are mixed into the wet concrete and poured with the concrete to form a reinforced concrete structure. The properties of the reinforced concrete can be tuned by using mixtures of composites with different reinforcing fibers or mixtures of composites and non-composite fibers.

### BACKGROUND OF THE INVENTION

This invention relates to reinforcing materials for concrete and concrete structures so reinforced.

Concrete is one of the most common building materials. It is used in a wide variety of structures such as bridges, walls, floors, building supports, roadways, and runways among many others.

For several reasons, concrete structures are usually made with some sort of reinforcement. Concrete is often prone to cracking as the structure is weathered or subjected to bending loads and impact. This is mainly due to the poor tensile properties of the concrete. Reinforcing materials are commonly used to improve the tensile properties of concrete structures. In addition, concrete is applied wet and in some instances must hold its position shape (against, e.g. the force of gravity) until it hardens. Sometimes reinforcing materials are added to the concrete to help hold the mass together and in position until it sets.

Concrete reinforcements come in several types. Reinforcing bars are common. These are typically steel but are sometimes a thermoset/fiber composite. A second type of reinforcement is an overwrap. The overwrap is commonly a thermoset/fiber composite that is applied to the outside of a structure. Overwraps of this sort are often used to shore up a cracked or damaged structure, or to strengthen structures so they become more resistant to natural phenomena such as hurricanes, tornadoes and earthquakes. Overwraps are not limited to concrete structures—they can be applied to structures of many types of construction, such as brick, stone, and frame constructions.

A third type of concrete reinforcement is fibers that are embedded in the concrete. The fibers used in this application are usually steel or polypropylene. These fibers are short, commonly of the order of 12-50 mm in length, and typically have a diameter of around 0.1-1 mm. The fibers are mixed into the wet concrete. When the concrete is poured, the fibers become randomly oriented in the concrete, forming a random skeletal structure that helps prevent cracking or crack propagation. This structure also helps hold the wet concrete together until it can harden.

The common steel and polypropylene fibers each have significant limitations. Steel fibers are very strong and stiff, but they are difficult to handle and apply. They are prone to corrosion when exposed to water and salts. Polypropylene fibers do not corrode, but are undesirably ductile and not as strong as desired. Further, with all fibers but especially strong stiff fibers such as steel, it is relatively difficult to generate the full strength of the fibers since they do not bond adequately to the concrete so that when a load is applied, they tend to pull out below their ultimate failure strength.

Glass fibers would have an excellent combination of stiffness, strength and resistance to corrosion, but they are too brittle for this application. The process of mixing glass fibers into the concrete and pouring the concrete breaks the fibers up into short lengths that do not provide much reinforcement. In addition, glass fibers are not chemically stable in the alkaline environment of concrete.

In order to overcome the deficiencies of glass fibers, it has been attempted to provide them with a polymeric coating. The polymeric coating would be expected to reduce the friability of the glass fibers as well as protect them from the alkalinity of the concrete. However, it is difficult and expensive to provide glass fibers with a suitably thin coating that also completely covers the fibers.

Thus, it would be desirable to provide an improved method by which reinforcement can be provided to concrete, which provides high strength and stiffness combined with ease of handling, no corrosion and excellent mechanical and/or chemical bonding into the concrete.

### SUMMARY OF THE INVENTION

In one aspect, the present invention is a reinforced structure comprising concrete interspersed with a plurality of composites having a longest cross-sectional dimension of not more than about 5 mm and an aspect ratio of at least 10, wherein each composite contains a plurality of reinforcing fibers embedded in a matrix of a thermoplastic resin selected from the group consisting of polystyrene, polyvinyl chloride, ethylene vinyl acetate, ethylene-acrylic acid copolymer, ethylene vinyl alcohol, polybutylene terephthalate, polyethylene terephthalate, acrylonitrile-styrene-acrylic, ethylene-styrene interpolymer, ABS (acrylonitrile-butadiene-styrene), polypropylene, and polyethylene.

In a second aspect, the present invention is a reinforced structure comprising concrete interspersed with a plurality of first fiber-reinforced composites and either or both of a) a plurality of second fiber-reinforced composites and b) non-composite fibers; wherein the first and second composites contain a plurality of reinforcing fibers embedded in a matrix of a thermoplastic resin, with the proviso that the first composite is embedded with fibers that are different from the fibers in the second composite, wherein each composite has a longest cross-sectional dimension of not more than about 5 mm and an aspect ratio of at least 10.

### BRIEF DESCRIPTION OF THE DRAWINGS

FIGS. 1 and 2 are isometric views of embodiments of the invention.

### DETAILED DESCRIPTION OF THE INVENTION

The small cross-section, composite that is interspersed into concrete is advantageously prepared from a composite of continuous longitudinally oriented fibers embedded in a matrix of a thermoplastic resin, which is conveniently made in a pultrusion process as described in U.S. Pat. No. 5,891,560 to Edwards et al. By “small cross-section”, it is meant that the small cross-section composite has a longest cross-sectional dimension of no greater than about 5 mm.

The small cross-section composite advantageously has a longest cross-sectional dimension of up to 5 mm, preferably of up to about 2.5 mm. It has an aspect ratio of at least 10, preferably at least 25, more preferably at least 40. The small cross-section composite can have any convenient cross-sectional shape, including circular, elliptical, oval, semicircular, rectangular, square, or any other regular or irregular polygon shape, with or without a hollow core.

A typical small cross-section composite has a width of from about 0.2 to about 5 mm, preferably about 0.5 to about 2 mm, and a thickness of 0.1 to about 1 mm. A suitable length is from about 10 to about 100 mm, preferably about 15 to about 75, more preferably 25 to about 60 mm.

The small cross-section composite preferably has some curvature, bending, or surface deformation that provides sites for interlocking with the cured concrete. The curvature can take the form, e.g., of a sinusoidal curve or wave throughout the length of the small cross-section composite, or can take the form of one or more, preferably at least two, localized curves or bends. FIGS. 1 and 2 illustrate exemplary ways how this curvature or bending can appear. In FIG. 1, small cross-section composite 1 is generally flat but has sinusoidal curve 6 running throughout its length. In FIG. 2, small cross-section composite 4 has terminal curves 2 and 3, forming terminal sections 7 and 8 that are angled with respect to the plane of the main portion 9 of the small cross-section composite. Another way to provide for mechanical keying into the concrete is to form a spiraled composite having any non-circular cross-section. This effect can be obtained by pultruding any cross-sectional shape except a circle, and either twisting the pultruded mass after it exits the die or rotating the die during the pultrusion process.

The fiber can be any strong, stiff fiber that is capable of being impregnated into a thermoplastic matrix so as to form the fiber-reinforced composite. Suitable fibers are well known and are commercially available. Glass, other ceramics such as SiC, boron, B₄C, Al₂O₃, MgO and Si₃N₄, carbon, metal or high melting polymeric (such as aramid) fibers are suitable. Mixtures of different types of fibers within a single matrix can be used. For example, combinations of steel, glass, ceramic, and aramid microfibers can be embedded in the matrix, which can be reduced in size to the desired dimension and interspersed with the concrete. The embedded fiber may be continuous through the matrix (for example, by way of a pultrusion process) or shorter than the length of the matrix (for example, through an extrusion process).

The fibers of the different types can also be layered or interwoven within the single matrix to optimize certain desired properties. For example, glass fibers can be used in the interior regions of the small cross-section composite and more expensive fibers such as carbon fibers used in the exterior regions. This permits one to obtain the benefits of the high stiffness of the carbon fibers while reducing the overall fiber cost. In addition, the exterior carbon fibers provide additional protection of the glass fibers from the alkaline environment in the cement. Glass is a preferred fiber due to its low cost, high strength and good stiffness.

Alternatively, a mixture of composites reinforced with different fibers can be interspersed into the concrete. For example, three different fiber-reinforced composites, one reinforced with steel fibers, one with glass fibers, and one with aramid fibers, can be interspersed into the concrete. Additionally, mixtures of composites and non-composite fibers, such as steel fibers or polypropylene fibers, can be interspersed into the concrete.

Suitable fibers are well known and commercially available. Fibers having diameters in the range of about 10 to 50 microns, preferably about 15-25 microns, are particularly suitable.

The fibers are preferably longitudinally oriented in the small cross-section composite. By “longitudinally oriented”, it is meant that the fibers extend essentially continuously throughout the entire length of the small cross-section composite, and are aligned in the direction of pultrusion.

As it is the fibers that mainly provide the desired reinforcing properties, the fiber content of the small cross-section composite is preferably as high as can conveniently be made. The upper limit on fiber content is limited only by the ability of the thermoplastic resin to wet out the fibers and adhere them together to form an integral composite without significant void spaces. The fibers advantageously constitute at least 15 volume percent of the small cross-section composite, preferably at least 30 volume percent and more preferably at least 50 volume percent.

The thermoplastic resin can be polystyrene, polyvinyl chloride, ethylene vinyl acetate, ethylene-acrylic acid copolymer, ethylene vinyl alcohol, polybutylene terephthalate, polyethylene terephthalate, acrylonitrile-styrene-acrylic, ethylene-styrene interpolymer, ABS (acrylonitrile-butadiene-styrene), polyethylene, polypropylene, or blends thereof. If polyethylene or polypropylene are used as the thermoplastic matrix, it may be desirable to include a compatibilizing amount of a compatibilizer for the polyolefin to increase bonding between the fiber and the resin as well as to increase bonding between the concrete and the fiber-reinforced composite. Suitable compatibilizers include ethylene-acrylic acid copolymer as well as polyethylene or polypropylene grafted with a polar substituent, such as maleic anhydride (MAH), carboxylic acid, and the like. For example, 70 to 98 weight percent low density polyethylene, from about 1 to about 10 weight percent low density polyethylene-g-MAH, preferably from about 1 to about 10 mole percent MAH, and from about 1 to about 20 weight percent ethylene-acrylic acid copolymer can be blended to form a preferred compatibilized matrix that adheres to fibers and concrete. In an analogous example using polypropylene as the resin matrix, 70 to 98 weight percent polypropylene, from about 1 to about 10 weight percent polypropylene-g-MAH, preferably from about 1 to about 10 mole percent MAH, and from about 1 to about 20 weight percent ethylene-acrylic acid copolymer can be blended to form a preferred compatibilized matrix that adheres to fibers and concrete.

The fibers can be impregnated into the matrix resin by conventional means well known in the art of pultrusion, for example, by drawing the fibers through a bath or a die containing a melt of the thermoplastic resin. Impregnation can also be accomplished by commingling thermoplastic resin fibers with the reinforcing fibers and drawing these commingled fibers into a heated zone at a temperature sufficiently high to substantially or completely melt the thermoplastic fibers, but not the reinforcing fibers, so as to promote impregnation of the reinforcing fiber into the thermoplastic matrix.

The small cross-section composite of this invention is conveniently prepared by pultruding a composite in the form of one or more small cross-sectional rods or tubes, which can then be cut to the desired length. Alternatively, the small cross-section composite can be prepared by pultruding a thin sheet of composite and, in either order, cutting the composite in the direction of the fibers to the desired width to form small cross-section strips, and cutting the strips to the desired length. The preferred curvature can be imparted to the small cross-section composite on-line, preferably before cutting to size. Less preferably, this can be done in a subsequent operation.

A rough surface finish can easily be imparted to the composite during manufacturing. Also, the ends of the fibers can easily be deformed as they are cut to length. The deformation is achieved by ‘squashing’ the ends of the fiber with the cutter at the same time it cuts. Both of these two methods of imparting rough surface greatly enhance the bond between the fibers and the concrete and are simple and efficient to achieve. Indeed, a rough surface is actually easier to impart to the composite than a smooth surface; manufacturers often have to go to great lengths to achieve smooth pellets and to prevent squashing of the ends in the normal commercial production of long fiber filled pellets for injection molding.

To introduce curves, the impregnated fiber bundle exiting the consolidation unit is conveniently fed through a subsequent moving die that forms a curved or crimped form into the part. A caterpillar-type die having matched dies that act on the profile to form the curves, as described in U.S. Pat. No. 5,798,067 to Long, is suitable. Alternatively, a pair of oscillating matched dies can be used to produce a similarly curved profile. Because the matrix resin is a thermoplastic, the introduction of curves using either of these methods can also be done off-line, i.e., separate from the pultrusion process.

Curves or bends of the type illustrated in FIG. 2 can also be introduced in a post-forming process, by reheating the composite to a temperature at which the DRTP softens, forming the softened composite into the desired shape, and then cooling. Again, this is preferably done before the sheet is cut down.

The small cross-section composite of the invention is conveniently used in the same manner as are conventional steel or polypropylene fibers. The small cross-section composite is blended into the wet concrete, either before or after the dry cement or mortar is mixed with water, and mixed to disperse the small cross-section composite throughout the mix. As used herein, “concrete” is used in the usual sense of meaning a mixture of a particulate filler such as gravel, pebbles, sand, stone, slag or cinders in either mortar or cement. Suitable cements include hydraulic cements such as Portland cement, and aluminous cement. The cement or concrete may contain other ingredients such as, for example, plastic latex, hydration aids, curatives, and the like. In addition to the small cross-section composite, other fibers can be included, such as polymeric one-component fibers, bi-component fibers, carbon fibers, ceramic fibers, glass fibers and wood fibers.

The concrete containing the dispersed small cross-section composite is then shaped in any convenient manner (such as pouring or the so-called shotcrete process) and allowed to cure to form the concrete structure. A large variety of concrete structures can be made in accordance with the invention, including road surfaces, aircraft runways, walls, building walls and floors, foundations, retaining walls, culverts, tunnels, pillars, and the like. Of course, the small cross-section composite of the invention can be used in conjunction with other types of reinforcements, such as rebars, overwraps and the like.

The small cross-section composite will generally constitute up to 10 volume percent of the concrete mixture, preferably from about 0.1 to about 10 volume percent and more preferably from about 0.5 to 2 volume-percent.

The resulting concrete structure contains the small cross-section composite embedded within the concrete. The individual pieces of small cross-section composite are advantageously oriented randomly within the concrete, thereby producing omnidirectional reinforcement. In addition, the small cross-section composite helps to hold the wet concrete in place until it has had time to cure, in much the same way as conventional fibers do.

An important aspect of the invention is that it permits the use of glass fibers as reinforcing materials for concrete. The thermoplastic matrix of the small cross-section composite helps overcome the problem of brittleness that is associated with plain glass fibers. This permits the small cross-section composite to withstand the mixing and pouring processes without significant breakage. In addition, it is believed that the thermoplastic resin matrix isolates the glass from the alkaline environment of the cement, slowing or preventing the chemical deterioration of the glass.

What is claimed is:

1. A reinforced structure comprising concrete interspersed with a plurality of fiber-reinforced composites having a longest cross-sectional dimension of not more than about 5 mm and an aspect ratio of at least 10, wherein each composite contains a plurality of reinforcing fibers embedded in a matrix of a thermoplastic resin selected from the group consisting of polystyrene, polyvinyl chloride, ethylene vinyl acetate, ethylene-acrylic acid copolymer, ethylene vinyl alcohol, polybutylene terephthalate, polyethylene terephthalate, acrylonitrile-styrene-acrylic, ethylene-styrene interpolymer, ABS (acrylonitrile-butadiene-styrene), polypropylene, and polyethylene.

2. The reinforced structure of claim 1, wherein the reinforcing fibers are longitudinally oriented and are glass, ceramic, carbon, metal or polymeric fibers or combinations thereof.

3. The reinforced structure of claim 2 wherein the reinforcing fibers include glass fibers.

4. The reinforced structure of claim 1, wherein the reinforcing fibers have a longest cross-sectional dimension of up to about 2.5 mm and an aspect ratio of at least about 25.

5. The reinforced structure of claim 3 wherein the thermoplastic resin is polyethylene.

6. The reinforced structure of claim 5, wherein the polyethylene is compatibilized with a compatibilizing amount of low density polyethylene-g-MAH and ethylene-acrylic acid copolymer.

7. The reinforced structure of claim 3 wherein the thermoplastic resin is polypropylene.

8. The reinforced structure of claim 7, wherein the polypropylene is compatibilized with a compatibilizing amount of polypropylene-g-MAH and ethylene-acrylic acid copolymer.

9. The reinforced structure of claim 1 wherein the composite is curved or bent, or wherein the surface of the composite is roughened or deformed.

10. A reinforced structure comprising concrete interspersed with a plurality of first fiber-reinforced composites and at least one of a) a plurality of second fiber-reinforced composites and b) non-composite fibers; wherein the first and second composites contain a plurality of reinforcing fibers embedded in a matrix of a thermoplastic resin, wherein the composites have a longest cross-sectional dimension of not more than about 5 mm and an aspect ratio of at least 10, with the proviso that the fibers of the first composites are different from the fibers of the second composites.

11. The reinforced structure of claim 10, which comprise non-composite fibers, wherein the fibers of the first composites are longitudinally oriented and are selected from the group consisting of glass, ceramic, carbon, metal, and aramid fibers, and wherein the non-composite fibers are selected from the group consisting of steel and polypropylene fibers.

12. The reinforced structure of claim 10, which comprises a plurality of second fiber-reinforced composites wherein both the first and the second composites contain a plurality of longitudinally oriented reinforcing fibers embedded in the matrix of the thermoplastic resin.

13. The reinforced structure of claim 10, wherein the fiber-reinforced composites have a longest cross-sectional dimension of up to about 2.5 mm and an aspect ratio of at least about 25.

14. The reinforced structure of claim 13, wherein the fiber-reinforce composites have an aspect ratio of at least 40 and a length of 25-75 mm.

15. The reinforced structure of claim 10, wherein the thermoplastic resin is polypropylene or polyethylene.

16. The reinforced structure of claim 15, wherein the thermoplastic resin is polypropylene and the composite is curved or bent, or wherein the surface of the composite is roughened or deformed.
